(19) United States
(12) Patent Application Publication
(10) Pub. No.: US 2026/0228978 A1
(43) Pub. Date: Aug. 6, 2026

(54) METHOD FOR GENERATING THREE-DIMENSIONAL OBJECTS

(71) Applicant: BULL SAS, LES-CLAYES-SOUS-BOIS (FR)

(72) Inventors: Anaïs DRUART, Grenoble (FR); Nicolas ARNAISE, Bourgoin-Jallieu (FR); Louis DEVEZE, FONTAINE (FR)

(73) Assignee: BULL SAS, LES-CLAYES-SOUS-BOIS (FR)

(21) Appl. No.: 19/401,358

(22) Filed: Nov. 26, 2025

(30) Foreign Application Priority Data
Nov. 27, 2024 (EP) 24306985.3

(51) Int. Cl. G06T 17/20; G06T 19/20

(52) U.S. Cl. CPC G06T 17/205; G06T 19/20; G06T 2219/2021

(57) ABSTRACT

The invention relates to a method for generating three-dimensional objects, including extracting which includes generating a textual instruction to search, in a descriptive textual context of an appearance of a three-dimensional object, for a value of at least one predetermined attribute; and providing the generated textual instruction as input to a language model, in order to identify a value for each predetermined attribute, forming a corresponding extracted annotation. The method also includes providing the textual content, as input to a text-to-3D generative model, to generate a raw three-dimensional object; and storing the raw three-dimensional object, in association with each corresponding extracted annotation, as a generated three-dimensional object.

This application claims priority to European Patent Application Number 24306985.3, filed 27 Nov. 2024, the specification of which is hereby incorporated herein by reference.

### BACKGROUND OF THE INVENTION

### Field of the Invention

At least one embodiment of the invention relates to a method for generating three-dimensional objects.

At least one embodiment of the invention also relates to a computer program and a device implementing such a method.

At least one embodiment of the invention applies to the field of computer science, and more specifically to the generation of three-dimensional objects by a computer.

### Decription of the Related Art

It is known to generate three-dimensional scenes in order to create synthetic images, in particular for training artificial intelligence models, notably computer vision models.

Such an approach, while offering total control over the scene represented, generally requires a large number of three-dimensional objects (or “3D objects”) to populate said three-dimensional scene, particularly if a large and realistic scene is desired.

Typically, such 3D objects are acquired either directly from a 3D artist, or online from 3D object banks.

Nevertheless, such an approach is not entirely satisfactory.

Indeed, modeling several realistic three-dimensional scenes requires the acquisition of a large number of 3D objects, which translates into prohibitive costs.

Additionally, these 3D objects, which come from a variety of sources, generally do not meet the same storage and/or naming standards, which means that, for the user wishing to generate three-dimensional scenes, there is an additional human cost (financial and time) involved in guaranteeing a homogeneity of the 3D object database when each 3D object is purchased.

Additionally, the use of free 3D object banks is not an option, as such 3D objects are often of insufficient quality and/or limited variety.

One object of at least one embodiment of the invention is to overcome at least one of the drawbacks of the prior art.

Another aim of at least one embodiment of the invention is to propose a method for generating 3D objects capable of producing low-cost, high-quality 3D objects whose metadata comply with formatting rules previously imposed by a user.

### BRIEF SUMMARY OF THE INVENTION

To this end, the one or more embodiments of the invention relates to a method of the above-mentioned type, implemented by computer and comprising:
an extraction step comprising:
   generating, based on at least one predetermined attribute and on a descriptive textual context of an appearance of a three-dimensional object to be generated, a textual instruction to search, in said textual context, for a value of each predetermined attribute; and
   providing, as input to a language model, the generated textual instruction,
   a value identified by the language model, in the textual context, of each predetermined attribute, forming a corresponding extracted annotation;
a creation step comprising providing the textual context as input to a text-to-3D generative model,
an output of the text-to-3D generative model forming a raw three-dimensional object; and
a step for storing the raw three-dimensional object, in association with each corresponding extracted annotation, as a generated three-dimensional object.

Indeed, the use of the text-to-image generative model confers the ability to generate three-dimensional objects according to the specific needs of the user, indicated in the textual context. In this fashion, a wide range of categories is accessible, and rapid generation of three-dimensional objects is possible.

In addition, the use of the language model, together with the generative model, enables an automatic extraction of the attributes of the three-dimensional object created. The result is automatic, uniform and consistent organization of the memory location wherein the generated three-dimensional objects are stored.

Advantageously, the method according to one or more embodiments of the invention has one or more of the following features, taken in isolation or according to any technically possible combination:

the method comprises a modification of a mesh of the raw three-dimensional object, prior to the storage thereof;

the modification of the mesh of the raw three-dimensional object comprises the implementation of at least one processing from:
a deletion of edges having a distance between them less than a predetermined minimum distance;
a smoothing of corners; and/or
a quadric edge collapse decimation;

prior to the creation step, the method comprises selecting the text-to-3D generative model from a plurality of predetermined text-to-3D generative models;

the method comprises:
prior to the creation step, in response to a usage request sent by a user, creation of a current container from an image comprising a pre-configured version of the text-to-3D generative model and, preferably, at least one ancillary library; and
after the storage step, in response to an end-of-use request sent by the user, deletion of the current container;

the image further comprises a previously configured version of the language model.

According to at least one embodiment of the invention, a computer program is provided which comprises executable instructions, which, when they are executed by a computer, implement the steps of the method as defined above.

The computer program can be in any computer language, such as, for example, in machine language, in C, C++, JAVA, Python, etc.

According to at least one embodiment of the invention, a computer device for generating three-dimensional objects is proposed, the computer device comprising:
a memory configured to store a text-to-3D generative model and a language model; and
a processing unit configured to:
   generate, based on at least one predetermined attribute and on a descriptive textual context of an appearance of a three-dimensional object to be generated, a textual instruction to search, in said textual context, for a value of each predetermined attribute;
   provide the textual context as input to a text-to-3D generative model, an output of the text-to-3D generative model forming a raw three-dimensional object;
   provide the generated textual instruction as input to the language model,
   a value identified by the language model, in the textual context, of each predetermined attribute, forming a corresponding extracted annotation; and
   write the raw three-dimensional object to memory, in association with each corresponding extracted annotation, as a generated three-dimensional object.

The device according to one or more embodiments of the invention can be any type of apparatus such as a server, a computer, a tablet, a calculator, a processor, a computer chip, programmed to implement the method according to at least one embodiment of the invention, for example by running the computer program according to one or more embodiments of the invention.

### BRIEF DESCRIPTION OF THE DRAWINGS

The one or more embodiments of the invention will be better understood from reading the following description, which is given solely by way of non-limiting example and with reference to the accompanying drawings. These show:

FIG. 1 is a schematic depiction of a computer device according to one or more embodiments of the invention; and

FIG. 2 is a flowchart of a method for generating three-dimensional objects implemented by the computer device of FIG. 1, according to one or more embodiments of the invention.

### DETAILED DESCRIPTION OF THE INVENTION

It is clearly understood that the one or more embodiments that will be described hereafter are by no means limiting. In particular, it is possible to imagine variants of the one or more embodiments of the invention that comprise only a selection of the features disclosed hereinafter in isolation from the other features disclosed, if this selection of features is sufficient to confer a technical benefit or to differentiate the one or more embodiments of the invention with respect to the prior art. This selection comprises at least one preferably functional feature which is free of structural details, or only has a portion of the structural details if this portion alone is sufficient to confer a technical benefit or to differentiate the one or more embodiments of the invention with respect to the prior art.

In particular, all of the described variants and embodiments can be combined with each other if there is no technical obstacle to this combination.

In the figures and in the remainder of the description, the same reference has been used for the features that are common to a number of figures.

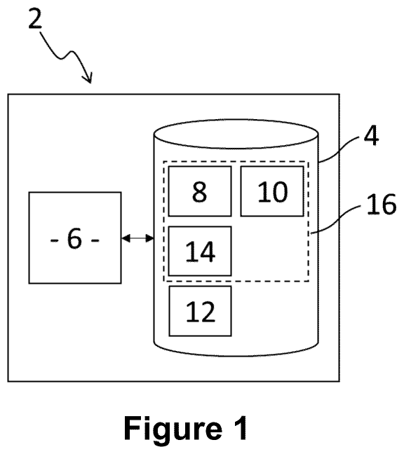

A computer device 2 according to one or more embodiments of the invention is exemplified by FIG. 1.

The computer device 2 comprises a memory 4 and a processing unit 6 connected to one another.

### Memory 4

The memory 4 is configured to store at least one generative model 8, as well as a language model 10.

Additionally, the memory also comprises a storage location 12 for three-dimensional objects (known as a “storage location”).

Advantageously, the memory 4 is also configured to store a three-dimensional object post-processing software 14 (known as “post-processing software”).

### Generative Model 8

The generative model 8 is a text-to-3D generative model.

More precisely, such a model is adapted to receive, as input, a descriptive textual context of an appearance of a three-dimensional object to be generated, and to produce, as output, a three-dimensional object corresponding to said textual context.

In particular, the textual context comprises desired attributes for the three-dimensional object to be generated. Such attributes are, for example, indicative of the type of three-dimensional object, or else other aspects related to the appearance and/or to the physical properties thereof, such as its dimensions (height, width and/or depth), its color, its ability to support other objects, its texture, its graphic style, the relative positions of its parts (in the case of an articulated object), etc.

For example, the generative model 8 is the DreamFusion model, as described by Ben Poole et al. in the digital prepublication “DreamFusion: Text-to-3D using 2D Diffusion”, referenced arXiv:2209.14988.

Such a distribution model is distinguished by its ability to generate objects quickly (around 20 minutes with the default configuration), with relatively few anomalies. Additionally, the DreamFusion model has the ability to generate living objects (plants, animals).

Alternatively, or complementarily, the generative model 8 is the Magic3D model, as described by Chen-Hsuan Lin et al. in the digital prepublication “Magic3D: High-Resolution Text-to-3D Content Creation”, referenced arXiv:2211.10440.

Such a model is also capable of generating objects quickly (around 45 minutes with the default configuration), and with a restricted number of edges. It additionally has the advantage of generating everyday objects (bags, furniture, tools, etc.) more realistically than the DreamFusion model.

### Language Model 10

The language model 10 has been previously trained to capture the semantics of a natural language text provided as input.

In particular, the language model 10 is a Large Language Model (LLM).

For example, the language model 10 is the Llama 3.2 model as described by Dubey Abhimanyu et al. in the digital prepublication “The Llama 3 Herd of Models”, referenced arXiv:2407.21783.

In particular, the language model 10 is adapted:
to receive, as input, a textual instruction to search, in a given text, for a value in at least one predetermined category; and
to provide, as output, an identified value, in said text, for each predetermined category.
   Post-processing software 14

The post-processing software 14 is configured to modify a mesh of a three-dimensional object provided as input.

Preferably, the post-processing software 14 is configured to modify the mesh of the three-dimensional object by the implementation of at least one processing from:
a deletion of edges having a distance between them less than a predetermined minimum distance;
a smoothing of corners; and/or
a Quadric edge collapse decimation.

Such a feature is advantageous, as it often leads to a consequent simplification of the three-dimensional object, thus reducing the space it occupies in the memory 4.

Advantageously, the generative model 8 and the language model 10 are together stored in a so-called “image” archive file 16. Such an image 16 has characteristics suitable for generating at least one instance wherein the generative model 8 can be implemented. Such an instance is called a “container”.

Advantageously, the language model 10 is also stored in the image, together with the generative model 8. In this case, the image 16 additionally has suitable characteristics for the generative model 8 to be able to be implemented in the generated instance.

For example, the image 16 is a Docker image, exploited using Docker Engine software developed by Docker, Inc.

In this case, each of the generative model 8 and of the language model 10 in the image 16 have a pre-determined configuration, for example to provide optimum performance for a specific use case.

The advantages of using such an image will be described later.

Preferably, the image 16 also comprises any ancillary libraries required to implement models 8, 10.

Even more preferably, the image 16 further comprises the post-processing software 14.

### Processing Unit 6

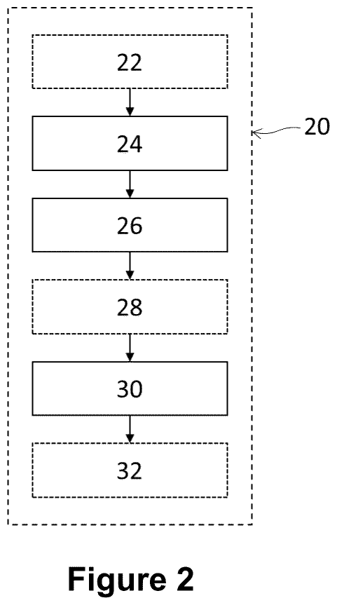

The processing unit 6 is configured to implement a method 20 for generating three-dimensional objects (known as the “3D generation method”), exemplified in FIG. 2, according to one or more embodiments of the invention.

As shown in this figure, the 3D generation method 20 comprises an extraction step 24, a creation step 26 and a storage step 30.

Preferably, the 3D generation method 20 further comprises a container creation step 22, prior to the creation step 26. In this case, the 3D generation method 20 also comprises a container removal step 32, subsequent to the storage step 30.

Even more preferably, the 3D generation method 20 also comprises a modification step 28, between the creation step 26 and the storage step 30.

The sequence of steps 24 to 32 can be performed a plurality of times, each iteration corresponding to the generation of a new three-dimensional object.

### Container Creation Step 22

Preferably, in the case where the generative model 8 (and, preferably, the language model 10) is stored in an image 16, the processing unit 6 is configured to create, during the container creation step 22, a current container from the image 16.

In particular, the processing unit 6 is configured to create the current container, from the image 16, in response to a usage request sent by a user.

### Extraction Step 24

The processing unit 6 is configured to wait, during the extraction step 24, for the user to enter a descriptive textual context of an appearance of a three-dimensional object to be generated.

An example of such a textual context is: “a large realistic white garden table”.

Additionally, when such a textual context is received, the processing unit 6 is configured to generate a corresponding textual instruction.

More specifically, the processing unit 6 is configured to generate the textual instruction from the textual context entered by the user and at least one predetermined attribute.

More precisely still, the textual instruction is a textual instruction to search for a value of each predetermined attribute, in the textual context.

For example, in the case of the textual context indicated previously, the textual instruction is: “determine the value taken by each from: a category, a sub-category, an ability to support other objects (true or false), a height in meters, a width in meters, and a color, from the following text: ‘a large realistic white garden table”.

The processing unit 6 is also configured to provide the generated textual instruction as input to the language model 10.

In this case, a value identified by the language model 10, in the textual context, of each predetermined attribute, forms a corresponding extracted annotation.

In the case of the textual instruction attributes provided as an example, the annotations obtained are:
category: furniture;
subcategory: table;
ability to support other objects: true;
height in meters: 1.3;
width in meters: 1.5; and
color: white.

The extraction step 24 can be implemented before, after or in parallel with step 26 for creating a raw three-dimensional object. Preferably, the extraction step 24 is implemented before the step 26 of creating the raw three-dimensional object, and more precisely as soon as the user enters the descriptive textual context of the appearance of the three-dimensional object to be generated.

### Creation Step 26

Preferably, if the memory 4 stores a plurality of predetermined text-to-3D generative models, the creation step 26 is preceded by a selection of the generative model to be implemented from said plurality of generative models.

Additionally, optionally, the implementation of the creation step 26 is preceded by a manual configuration of the generative model 10 by the user.

Such a configuration corresponds, for example, to a desired format for the raw three-dimensional object to be created.

Additionally, when such a textual context is received, the processing unit 6 is configured to provide the received textual context as input to the generative model 8.

In this case, an output of the generative model 8 forms a raw three-dimensional object.

### Modification Step 28

Preferably, during the modification step 28, the processing unit 6 is configured to implement the processing software 14 on the basis of the raw three-dimensional object provided at the output by the generative model 8.

The result is a raw three-dimensional object updated by modifying the corresponding mesh.

### Storage Step 30

The processing unit 6 is also configured, during the storage step 30, to write the raw three-dimensional object obtained, in association with the corresponding extracted annotations, to the storage location 12 in the memory 4.

The assembly comprising the raw three-dimensional object and the corresponding annotations forms the generated three-dimensional object.

Preferably, if the storage location 12 has a database structure, the processing unit 6 is configured to store each annotation in the memory space of the database that relates to the corresponding attribute.

### Container Deletion Step 32

Preferably, during the container deletion step 32, the processing unit 6 is configured to delete the current container in response to an end-of-use request sent by the user.

The use of such containers, with pre-configured models 8, 10, is advantageous in that it drastically reduces the costs associated with the use of the graphics processors required, notably, to run the generative model.

On the other hand, a slightly longer initial operating time is passed on to the user, should he wish to apply his own configurations to the models 8, 10.

### Operation

The operation of the computer device 2 will now be described, referring to FIG. 2, according to one or more embodiments of the invention.

Preferably, in the case where the generative model 8 and the language model 10 are stored in an image 16, the processing unit 6 creates, during the container creation step 22, a current container from said image 16.

In particular, the processing unit 6 creates the current container in response to a usage request sent by a user.

Then, preferably in the case where the memory 4 stores a plurality of predetermined generative models, the user selects a generative model to implement.

Then, optionally, the user configures the generative model 10 (in particular the selected generative model 10).

Then, during the extraction step 24, in response to the input, by the user, of a descriptive textual context of an appearance of a three-dimensional object to be generated, the processing unit 6 generates a textual instruction based on said textual context entered and on at least one predetermined attribute.

Then, the processing unit 6 provides the generated textual instruction as input to the language model 10. The result, at the output of the language model 10, is a corresponding extracted annotation for each predetermined attribute.

Additionally, during the creation step 26, the processing unit 6 provides the textual context entered by the user as input to the generative model 8. The result, at the output of the generative model 8, is a raw three-dimensional object.

Then, preferably during the modification step 28, the processing unit 6 implements the processing software 14 to update said raw three-dimensional object delivered by the generative model 8.

Then, during the storage step 30, the processing unit 6 writes the resulting raw three-dimensional object, in association with the corresponding extracted annotations, to the storage location 12 of the memory 4. The assembly comprising the raw three-dimensional object and the corresponding annotations forms the generated three-dimensional object.

Then, preferably during the container deletion step 32, in response to an end-of-use request sent by the user, the processing unit 6 deletes the current container.

Of course, the at least one embodiment of the invention is not limited to the examples disclosed above.

1. A method for generating three-dimensional objects, the method being implemented by a computer, the method comprising:
an extraction step that comprises
generating, based on at least one predetermined attribute and on a textual context describing an appearance of a three-dimensional object to be generated, a textual instruction to search, in said textual context, for a value of each predetermined attribute of said at least one predetermined attribute; and
providing, as input to a language model, the textual instruction that is generated,
wherein a value identified by the language model, in the textual context, of said each predetermined attribute, forms a corresponding extracted annotation;
creation step comprising providing the textual context as input to a text-to-3D generative model, an output of the text-to-3D generative model forming a raw three-dimensional object; and
storing step that stores the raw three-dimensional object, in association with each corresponding extracted annotation, as a generated three-dimensional object.

2. The method according to claim 1, further comprising modifying a mesh of the raw three-dimensional object, prior to the storing step thereof.

3. The method according to claim 2, wherein the modifying the mesh of the raw three-dimensional object comprises implementing at least one processing among:
deletion of edges having a distance between them less than a predetermined minimum distance;
smoothing of corners; and/or
quadric edge collapse decimation.

4. The method according to claim 1, further comprising, prior to the creation step, a selection of the text-to-3D generative model from a plurality of predetermined text-to-3D generative models.

5. The method according to claim 1, further comprising:
prior to the creation step, in response to a usage request sent by a user, creating a current container based on an image comprising a pre-configured version of the text-to-3D generative model and, at least one ancillary library; and
after the storing step, in response to an end-of-use request sent by the user, deleting the current container.

6. The method according to claim 5, wherein the image additionally comprises a previously configured version of the language model.

7. A computer program comprising executable instructions which, when executed by a computer, cause the computer to implement a method for generating three-dimensional objects, the method being implemented by a computer, the method comprising:
an extraction step that comprises
generating, based on at least one predetermined attribute and on a textual context describing an appearance of a three-dimensional object to be generated, a textual instruction to search, in said textual context, for a value of each predetermined attribute of said at least one predetermined attribute; and
providing, as input to a language model, the textual instruction that is generated,
wherein a value identified by the language model, in the textual context, of said each predetermined attribute, forms a corresponding extracted annotation;
a creation step comprising providing the textual context as input to a text-to-3D generative model, an output of the text-to-3D generative model forming a raw three-dimensional object; and
a storing step that stores the raw three-dimensional object, in association with each corresponding extracted annotation, as a generated three-dimensional object.

8. A computer device that generates generating three-dimensional objects, the computer device comprising:
a memory configured to store a text-to-3D generative model and a language model; and
a processor configured to:
generate, based on at least one predetermined attribute and on a descriptive textual context of an appearance of a three-dimensional object to be generated, a textual instruction to search, in said descriptive textual context, for a value of each predetermined attribute;
provide the descriptive textual context as input to a text-to-3D generative model, an output of the text-to-3D generative model forming a raw three-dimensional object;
provide the textual instruction that is generated as input to the language model,
wherein a value identified by the language model, in the descriptive textual context, of said each predetermined attribute, forms a corresponding extracted annotation; and
write, in the memory, the raw three-dimensional object in association with each corresponding extracted annotation, as a generated three-dimensional object.
